(19) United States
(12) Patent Application Publication
(10) Pub. No.: US 2008/0012239 A1
(43) Pub. Date: Jan. 17, 2008

(54) Abrasion oil and solvent resistant coating for tunnel segment gaskets

(76) Inventors: Bradford G. Corbett JR., Fort Worth, TX (US); Richard Hirst, Fort Worth, TX (US)

Correspondence Address: Charles D. Gunter, Jr.;Whitaker, Chalk. Swindle & Sawyer, LLP, STE 3500, 301 Commerce Street, Fort Worth, TX, 76102-4186, US

(21) Appl. No.: 11/818,247

(22) Filed: Jun. 13, 2007

Related U.S. Application Data
(60) Provisional application No. 60/814,710, filed on Jun. 15, 2006.

(51) Int. Cl. F02F 11/00

(52) U.S. Cl. 277/592

(57) ABSTRACT

A profiled gasket for sealing tunnel segment joints, which is placed in a receiving groove between segments. The gasket is made of a body of rubber or an elastically deformable synthetic material having an external surface coating which improves the physical properties of the gasket. The coating can be a one-part, room temperature curing hydrogenated nitrile butadiene rubber base coating.

### CROSS REFERENCE TO RELATED APPLICATIONS

The present application claims priority from the earlier filed provisional application Ser. No. 60/814,710, filed Jun. 15, 2006, entitled “Abrasion, Oil and Solvent Resistant Coating For Tunnel Segment Gaskets.”

### BACKGROUND OF THE INVENTION

1. Field of the Invention

This invention relates to a sealing profile or gasket for use with tunnel segments. More particularly, this invention relates to a sealing profile made of rubber or a rubber-like material for installation in a recess extending around concrete segment tubes for use in tunnels or for shaft installations.

2. Description of the Prior Art

In modern tunnel construction, tunnels are typically built up of concrete blocks, which are usually called “segments.” It is necessary in such construction that sealing surfaces or profiles must be provided in the spaces between each two adjacent segments. To that end, each of such mating segments is typically provided with a groove. A sealing gasket or profile is located within each such groove, so that a seam is created between the gaskets which prevents leaks from occurring.

Profile gaskets for sealing tunnel segments are well known in the art. For example, issued U.S. Pat. Nos. 4,199,158; 6,267,536; 5,888,023; 4,824,289; and 5,074,711 are all exemplary of such prior art designs. The prior art sealing or packing profiles of the type shown in these references have been used successfully in tunnel construction and in shaft installations. However, advanced developments in connection with the engineering of tubes for tunnels and the like, have led to additional requirements which sealing profiles made of rubber or a rubber-like material must meet.

It is desirable that the sealing profiles be narrow in relation to the wall thickness of the concrete segments without, however, reducing the areas of contact of the sealing profiles. A large seal supporting surface has to be maintained on the concrete segments so as to avoid as much as possible any increased stressing of these segments. Furthermore, these profiles are expected to be resistant to the effects of abrasion solvents, oils and greases, in order to assure, for example, that the intended gluing or sealing of the profile in the recess of the concrete segment is adequately secure. The volume of the profile material disposed in the recess of the concrete segment should be set so that the profile is fully accommodated in the recess when the concrete segments are brought together.

At the present time, natural rubber, e.g., styrene butadiene rubber (SBR), is often used in railway pad, boot and component installations of the type used in tunnel construction. However, natural rubber or other existing elastomer compounds are not satisfactory to meet the requirements in all applications. There are various materials that will solve one problem, but not all combinations of problems. Particularly in Europe, new railway line standards require that, for example, railroad tie boots be ozone resistant. The raw SBR materials which have been used in the past will not meet the new standards for ozone resistance. A need exists, therefore, for a replacement product for the various elastomeric railway line and tunnel segment components discussed above which will meet the increased performance characteristics now being imposed.

Despite the various improvements which have occurred in materials and manufacturing techniques applied to railway tunnel segment gaskets and related elastomeric components, a need exists for a manufacturing technique which will allow the use of traditional elastomeric compounds while providing enhanced properties for these particular end applications.

A need also exists for such a technique which is economical to implement so that elastomeric goods are provided which are impact, ozone and oil resistant and yet are manufactured from more economical starting materials.

A need also exists for such a technique which can be implemented by dipping or spraying a coating on an exposed exterior surface of an elastomeric railway line component, such as a tunnel segment gasket, to give the goods enhanced performance and endurance characteristics.

In addition to the physical constraints imposed on the various tunnel segment gaskets designs discussed above, it would be desirable to provide a novel coating for the gasket which would assist in providing impact and abrasion resistance as well as improving oil and solvent resistance.

### SUMMARY OF THE INVENTION

The present invention concerns a profiled gasket for sealing tunnel segments of tunnels built up of segments where each segment is provided with such a profiled gasket arranged in a receiving groove provided therein. The profiled gasket of the invention comprises a body of rubber or an elastically deformable synthetic material, characterized in that the body has an external coating applied thereto. In one embodiment of the invention, the external coating is a nylon coating sold by Atofina Corporation under the brandname RILSAN®. The coating can be applied by either spraying on or by dipping the gasket or profile.

In another embodiment of the invention, the external coating comprises a synthetic, polymeric, polyurethane surface coating applied to at least selected portions of the exterior surface of the body. One preferred coating is a synthetic polymer, preferably thermoplastic, most preferably a polyurethane high performance coating that will withstand severe temperature, chemical attack and abrasion. A particularly preferred coating is manufactured by Lord Chemical Products of Erie, Pa., as the CHEMGLAZE®E polyurethane coating. This is a high performance coating that will withstand severe temperature, chemical attack and abrasion. Another particularly preferred coating is the Lord Elastomeric Coating manufactured by Lord Mechanical Products Division and marketed under the tradename ENDURALAST™ Tire Coating. The synthetic polymeric coatings of the invention can be applied by any technique generally used in the industry and is conveniently applied by spraying on at least selected internal or external surfaces of the gasket followed by a drying period as recommended by the manufacturer.

Another particularly preferred coating is manufactured by Lord Chemical Products, as the LORD HPC-5C™ coating. This coating is a one-part, room temperature curing hydrogenated nitrile butadiene rubber. In use, the base rubber material, such as styrene butadiene rubber, is provided with a single coat of CH7701™ primer plus a single coat of HPC-5C™ topcoat. The addition of the HPC-5C™ coating allows styrene butadiene rubber to meet ozone requirements, meet tensile strength and elongation after aging requirements, minimize flame propagation, decrease fume toxicity, and increase oil and fluid resistance.

Additional objects, features and advantages will be apparent in the written description which follows.

### BRIEF DESCRIPTION OF THE DRAWINGS

FIG. 1 is an isolated view of a portion of a tunnel constructed of a plurality of tunnel segments which are sealed with the sealing profile or gasket of the invention;

FIG. 2 is a cross-sectional view of the tunnel of FIG. 1, taken along line II-II; and

FIG. 3 is an isolated view of one of the tunnel segment profiles used in the practice of the present invention.

### DETAILED DESCRIPTION OF THE INVENTION

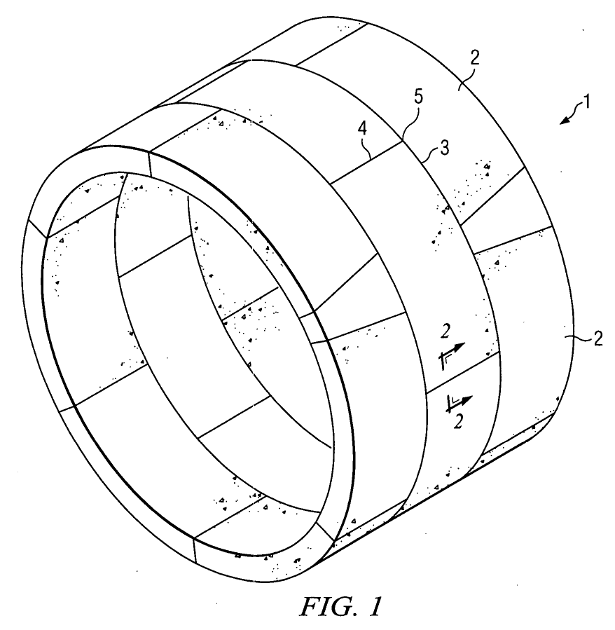

FIG. 1 shows a tunnel 1 consisting of segments 2 with the formation of transverse and longitudinal joints 3 and 4, respectively, as well as a T-joint arrangement 5. The various mating surfaces of the joints are sealed by means of the sealing profiles or gaskets having the special coating of the invention.

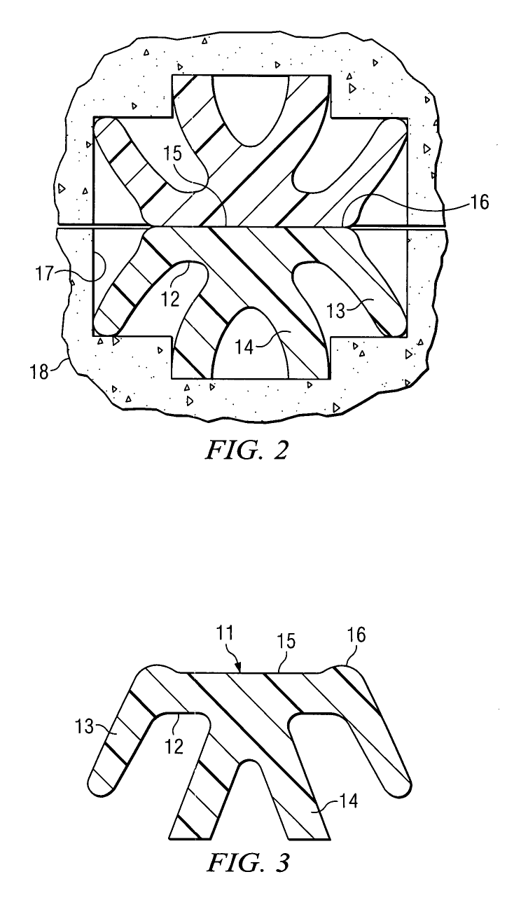

FIGS. 2 and 3 show one of the profiled gaskets of the invention. The gasket or profile shown in FIGS. 2 and 3 is merely intended to be illustrative of a prior art profile of the type to which the coating of the invention is applied. The gasket shown in FIGS. 2 and 3 has a body 11 of rubber or an elastically deformable synthetic material, of which one side 12 has two outer legs 13 and two inner legs 14. The opposite side 15 of the gasket has a flat central part and two longitudinal zones 16 which are slightly higher than this central part. The outer legs 13 are shorter than the inner legs 14. The lower edge of each of the outer legs has a corrugated shape.

As best seen in FIG. 2, the gaskets are each inserted in a receiving groove 17 of a tunnel segment 18 in such a way, that the sides 15 thereof lie against each other. The grooves 17 are carried out stepwise. Against the bottom of the deepest part of each of the grooves 17 lie the inner legs 14 of the profiled gasket. These inner legs essentially provide the sealing pressure, by which the sealing gaskets are pressed against each other when the segments are pressed towards each other during the construction of a tunnel.

It will be obvious from the discussion that follows that the invention is not restricted to the specific embodiment of the gasket or profile shown in FIGS. 2 and 3, but that it may be carried out in numerous other ways using gaskets of various designs without departing from the scope of the invention.

In the method of the invention, selected surfaces of the above described gasket or profile are coated with the external coating of the invention. Generally, at least the surface regions 15 in FIG. 3 are coated with the special external coating. Preferably, the entire gaskets or profiles have the coating applied thereto. One preferred class of materials is sold commercially by Lord Chemical Products of Erie, Pa., as the “Lord Elastomeric Coatings.” These elastomeric coatings have excellent adhesion properties and environmental resistance, and are capable of strains of several hundred percent. While the coatings can be applied directly to the exposed gasket surfaces, they can also be applied over existing elastomeric coatings or other synthetic or insulative coatings which are present on the gasket internal or external surfaces. The coatings can enable a less expensive material to be used in products with characteristics equivalent to more expensive materials. The coatings can be colored as well to indicate the type of gasket or profile being employed. These coatings can typically be applied by spraying on at least selected internal or external surfaces of the gasket followed by a drying period as recommended by the manufacturer.

One such example coating is a synthetic polymer, preferably thermoplastic, most preferably a polyurethane high performance coating that will withstand weather conditions, impact loading, chemical attack and abrasion. A particularly preferred coating is manufactured by Lord Chemical Products of Erie, Pa., as the CHEMGLAZE® polyurethane coating. This is a high performance coating that will withstand severe temperature, chemical attack and abrasion. The coating can be applied to any technique generally used in the industry and is conveniently applied by spraying on at least selected internal or external surfaces of the gasket followed by a drying period as recommended by the manufacturer. The spraying technique can be by conventional air atomized spray coating using a spray gun.

CHEMGLAZE® is an elastomeric polyurethane coating which exhibits inherent flexibility, corrosion resistance and energy absorbing properties. Manufacturers Technical Data for the product is as follows:

| Mix ratio A/B by volume | 3/1 supplied in premeasured kits | |
|---|---|---|
| Percent solids (by weight) | 56 | |
| Volatile Organic compounds | 3.5 | lb/gal |
| Tack Free time | 30 | min. |

Physical Properties of Cured Coatings:

| | | |
|---|---|---|
| Tensile strength ASTM D 412 | 5000 | psi |
| (Method A, Die C) | | |
| Percent Elongation ASTM D 412 | 500 | percent |
| (Method A, Die C) | | |

Taber Abraser

| | |
|---|---|
| CS17 1000 g/1000 cycles | No loss |
| Durometer Shore A | 110 |

Mixing and recommending spray application techniques are given in the manufacturer's REMR Material Data Sheet, CM-SE-1.9.

Another preferred class of coatings is the Lord Elastomeric Coating manufactured by Lord Mechanical Products Division and marketed under the tradename ENDURALAST™ Tire Coating. This product has excellent adhesion properties and environmental resistance and is capable of strains of several hundred percent.

The particularly preferred coating used in the present invention is manufactured by Lord as the HPC-5C™ coating. Lord HPC-5C™ is one-part, room temperature curing hydrogenated nitrile butadiene rubber (HNBR) coating which features robust adhesion and exceptional mechanical properties. The HPC-5C™ coating enhances fluid and ozone resistance for elastomeric substrates of the type under consideration, as will be described in greater detail below. HPC-5C™ is clear and colorable, and is composed of a mixture of polymers, organic compounds and fillers dissolved or dispersed in an organic solvent system.

The Lord HPC-5C™ has been found to offer the required characteristics for a coating used on railway line elastomeric components. HPC-5C™ has excellent adhesion, providing strong adhesion to substrate and elongation of up to 600%. Once properly applied, the coating does not crack or peel prior to substrate cracking. HPC-5C™ is also fluid resistant providing a fluid resistant barrier to external surface of elastomeric parts, allowing bulk of component to be made of less expensive, less fluid resistant material. The resulting system offers low cost, high mechanical properties with high fluid and environmental resistance. For example, HPC-5C™ provides excellent resistance to lubricating oils and transmission fluids. In addition, HPC-5C™ is ozone resistant, and provides a barrier to external surface of elastomeric parts of the type under consideration. Resultant systems offer low cost, high mechanical properties with high ozone resistance. Lastly, the HPC-5C is convenient, as application may be completed by spray, brush, dip or rolling coat methods and the coating can be easily incorporated into existing production lines. The coating cures at room temperature, and with hot air dry, it will cure in ten minutes (with full cure and adhesion develop over 48 hours).

Manufacturers Technical Data for the Lord HPC-5™ coating is as follows:

| Appearance | Clear Liquid with Orange Hue |
|---|---|
| Viscosity, cps @ 77° F. (25° C.) | 20-100 |

Density

| | |
|---|---|
| Lb/gal | 6.72-6.92 |
| (kg/m³) | (805.23-829.20) |

Solids Content, %

| | |
|---|---|
| by Weight | 10.6 |
| by Volume | 7.7-8.8 |
| Flash Point (Seta), ° F. (° C.) | 60 (15.6) |
| Solvents | Methyl Ethyl Ketone (MEK) |

The method of applying the coatings of the invention will now be described. Before applying the HPC-5C™ coating, the surfaces of all parts intended for coating must are prepared. For example, if exposed metal surfaces are present, these surfaces are preferably cleared with a solvent such as methanol. Wiping is the preferred method, but dipping or spray washing may also be acceptable. Alkaline cleaners may be substituted for the methanol, as well.

The elastomeric portion of railway line component is also preferably given a surface treatment to help ensure successful adhesion. This surface treatment varies depending upon the elastomer. Natural rubber stocks and styrene butadiene rubber stocks can successfully be treated with Chemlok 7701™. The part can be dipped as long as no metal portions come in contact with the Chemlok 7701™. Alternatively, Chemlok 7701™ can be brushed or wiped on. For natural rubber stocks with excessive amounts of antiozonants and other additives which may have bloomed to the surface, wiping with 7701 helps to remove these contaminants more effectively. A heavy red or purple residue on the rag as a result of a reaction between the Chemlok 7701™ and the surface additives is a good indication that there are excessive contaminants on the surface. The Chemlok 7701 is generally allowed to flash for 10 minutes or oven bake up to 250° F. (121° C.) for a few minutes. For very soft natural rubber stocks, utilizing a bake cycle during cure as described below may be necessary to obtain adhesion.

In order to mix the HPC-5™, it should be thoroughly stirred by hand or shaken before use. HPC-5 is normally used full strength for brush, dip and roller coat applications. For spray application, dilution up to 1:1 is recommended with ketone type solvents such as MEK.

As mentioned previously, in the preferred embodiment of the present invention, a less expensive rubber, such as SBR, is substituted for a more expensive rubber stock. SBR has acceptable abrasion, wear and tensile qualities, and may be readily substituted for more expensive rubber compounds with significant cost savings. However, much like natural rubber, SBR offers little resistance to oils and chemicals, and therefore requires additional resistance to ozone, sunlight, and heat. The present coating technique provides enhanced properties for the elastomeric component in qustion and provides an economical solution to the problem at hand.

As mentioned, there are several conventional techniques for applying the HPC-5C™ coating:

Brushing applies a coating for example using a camel hair or foam brush. The coating should be brushed onto the part in single strokes and dried for about 15 minutes at room temperature. Once dried, a second brushing of the coating will be generally necessary to obtain a desired film thickness in the general range from about 0.100 to about 3.00 mils, e.g., on the order of 0.235 mils. After the second coat is dry, it can be oven cured or cured at room temperature. Heat-assisted drying between coats to speed the process is also acceptable.

Dipping refers to the process of dipping the parts into the coating and removing the elastomeric components with a hanger or some method to hang the part vertically. If possible, it is best to reverse the orientation of the part on each dip so that equal film thickness is obtained on the entire surface of the part. It is preferable to allow the coating to dry for 15 minutes in between dips so that the coating thickness builds fully. Alternatively, the part may be oven dried for a few minutes at 150° F. (66° C.) in between dips.

Spraying can also be used to apply the coatings under consideration. Air pressure on the spray gun should generally be kept under about 30 psi. Oven drying at 150° F. (66° C.) once or twice during spraying may be necessary to build film the desired film thickness and avoid running.

The coatings used in the method of the invention can also have a color additive, such as a suitable pigment, dispersed therein which impart a distinctive color to the coated region of the elastomeric element. Color markings of this type can be used for product identification purposes. Pigments are commercially available from a number of sources such as Cleveland Pigment & Color Co., of Akron, Ohio. These pigments include, by way of example, organic, fluorescent, iron oxide, ultramarine pigments as well as chromium oxide greens and barytes. Another source of pigments is the FDA approved dyes and pigments.

In some applications, it may not be necessary to coat the entire outer surface of the rubber component under consideration. For example, with reference to the railway tie boot of FIG. 3, it will be appreciated that only the top lip 17 is exposed to the atmosphere once the tie is set into the surrounding concrete substrate. Thus, it may be possible to strategically apply a coating layer to only the ultimate exposed areas of the elastomeric component.

The following tests were carried out on SBR elastomeric components. SBR products provided by Maloney Technical Products. The SBR pads were tested for ozone cracking resistance per ISO 1431, with test conditions of 200 parts per hundred million (pphm) ozone concentration, 96 hours, 40 degrees C., 20% tension and crack classification 0 required to pass. The samples were wiped with methanol, then dipped for 2 seconds into Chemlok 7701™ adhesion promoter and allowed to dry. Coating was applied by dipping and air-dried for 3 days prior to testing. One and two coatings of both HPC-5C™ and HPC-6C™ were compared during the test. The following results were obtained, wherein σ (sigma) represents the standard deviation:

| Coating | Coating Thickness | Pass/fail |
|---|---|---|
| None(control) | 0.000 | failed at 48 hours |
| Coated with 1 coat | 0.400 mils, σ = 0.068 mils | pass |
| of HPC-6C ™ | | |
| Coated with 2 coats | 0.859 mils, σ = 0.172 mils | pass |
| of HPC-6C ™ | | |
| Coated with 1 coat | 0.235 mils, σ = 0.033 mils | pass |
| of HPC-5C ™ | | |
| Coated with 2 coats | 0.448 mils, σ = 0.077 mils | pass |
| of HPC-5C ™ | | |

The test results show that the proposed HPC-5C™ coating of the SBR material meets the above ozone requirement, whereas an uncoated control sample fails after 48 hours. HPC-5C™ was chosen as the preferred coatings because it dries faster and is a tougher, more abrasion resistant coating.

Another class of coatings which can be utilized in practicing the method of the invention are nylon coatings. The polyamides, or commonly named nylons are characterised by their number of carbon atoms in their molecular backbone (e.g. Polyamide 6 has six carbon atoms, Polyamide 11 has 11 carbon atoms). Generally speaking, the higher the number of carbon atoms involved in the polyamide the lower its melting point and moisture uptake. Nylon-based thermoplastic coating powders show excellent resistance to abrasion, impact, chemicals such alkalis, solvents, hydrocarbons, salt atmosphere and good electrical resistance and low coefficient of friction. The coatings provide excellent flexibility and when applied as thin films. The exterior durability provides excellent corrosion protection, adhesion and mechanical properties.

One preferred commercially available nylon coating is sold under the brand name RILSAN®, available from Atofina Corporation of Paris, France. RILSAN® is the Atofina brandname for the Polyamide 6, 11 and 12 family of nylon polymers.
RELSAN® 6 is a polyamide (−6-6) obtained from crude oil or castor oil.
RILSAN® A (polyamide 12) is obtained from the crude oil by polycondensation of laurylactame, available in granule form.
RILSAN® B (polyamide 11), obtained from castor oil, is a polymer 100% from vegetable origin, available in granule or powder grades.
RILSAN® Fine Powders (polyamide 11) are also obtained from castor oil.
   Properties:

RILSAN® Fine Powders are preferred for the present application and have multiple outstanding properties for high-performance coatings:
excellent abrasion resistance
exceptional resistance to corrosion and impact
outstanding flexibility
remarkable chemical inertia (impervious to alkalis, hydrocarbons, organic acids, diluted mineral acids, salts, esters, etc.)
ease of processing with a wide range of techniques
high thermal stability
good durability
good insulation properties, high resistance to humid environments
   Coating Techniques:

There are two main application techniques:

Dip-coating in a fluidized bed (for parts having sufficient heat capacity) the part to be protected is pre-treated, then heated in an oven and dipped in a bed of RILSAN® powder. The powder melts and forms a film by coalescence, in other words, by the fusion of the particles in contact with each other.

Electrostatic powder spraying: the electrically charged powder is applied with an electrostatic spray gun onto a cold substrate surface which has been pre-treated. Once the desired thickness is reached, the powder is fused by heating in an oven.

An invention has been provided with several advantages. The dipped or sprayed on coating reduces the mess associated with liquid lubricants which were often applied to the inside, outside or both surfaces of the prior art gaskets. The coating improves the shelf life of the gasket. Oxidation resistance is improved so that traditional gasket type elastomeric materials are offered added protection when exposed to direct sunlight. The coating of the invention provides a gasket which is more oil resistant than nitrile rubber but at a fraction of the cost. Colored coatings can be used to mark the product type, thereby making the particular gasket type easy to recognize. The coating assists in preventing infiltration of contaminants and assists in preventing leakage at the joints.

While the invention has been shown in several of its forms, it is not thus limited but is susceptible to various changes and modifications without departing from the spirit thereof.

What is claimed is:

1. A profiled gasket for sealing tunnel segments of tunnels built up of segments, each segment being provided with such a profiled gasket arranged in a receiving groove provided therein, the profiled gasket comprising:
a body of rubber or an elastically deformable synthetic material, characterized in that the body has an external coating applied thereto,
wherein the external coating comprises an external nylon abrasion and solvent resistant coating;

2. The gasket of claim 1, wherein the coating is selected from the group consisting of Polyamide 6, Polyamide 11 and Polyamide 12 nylon coatings.

3. The gasket of claim 1, wherein the external coating is a nylon coating sold by Atofina Corporation under the brandname RILSAN®.

4. The gasket of claim 1, wherein the external coating is sprayed on.

5. The gasket of claim 1, wherein the external coating is applied by dipping the gasket.

6. A profiled gasket for sealing tunnel segments of tunnels built up of segments, each segment being provided with such a profiled gasket arranged in a receiving groove provided therein, the profiled gasket comprising:
a body of rubber or an elastically deformable synthetic material, characterized in that the body has an external coating applied thereto;
wherein the external coating comprises a synthetic, polymeric, polyurethane surface coating applied to at least selected portions of the exterior surface of the body.

7. The gasket of claim 6, wherein the surface coating has the following published characteristics:

| Mix ratio A/B by volume | 3/1 supplied in pre-measured kits | |
|---|---|---|
| Percent solids (by weight) | 56 | |
| Volatile Organic compounds | 3.5 | lb/gal |
| Tack Free time | 30 | min. |

Physical Properties of Cured Coatings:

| | | |
|---|---|---|
| Tensile strength ASTM D 412 | 5000 | psi |
| (Method A, Die C) | | |
| Percent Elongation ASTM D 412 | 500 | percent |
| (Method A, Die C) | | |

Taber Abraser

| | |
|---|---|
| CS17 1000 g/1000 cycles | No loss |
| Durometer Shore A | 110 |

8. The gasket of claim 6, wherein the external coating is a synthetic, polymeric surface coating comprising ENDURALAST™ Tire Coating manufactured by Lord Chemical Corporation.

9. A profiled gasket for sealing tunnel segments of tunnels built up of segments, each segment being provided with such a profiled gasket arranged in a receiving groove provided therein, the profiled gasket comprising:
a body of rubber or an elastically deformable synthetic material, characterized in that the body has an external coating applied thereto;
wherein the external coating comprises a synthetic, polymeric surface coating applied to at least selected portions of the exterior surface of the elastomeric body, the surface coating comprising a one-part, room temperature curing hydrogenated nitrile butadiene rubber base coating.

10. The gasket of claim 9, wherein the elastically deformable synthetic material which is coated with the surface coating is a styrene butadiene rubber.

11. The gasket of claim 9, wherein the surface coating has the following published specifications:

| Appearance | Clear Liquid with Orange Hue |
|---|---|
| Viscosity, cps @ 77° F. (25° C.) | 20-100 |

Density

| | |
|---|---|
| Lb/gal | 6.72-6.92 |
| (kg/m³) | (805.23-829.20) |

Solids Content, %

| | |
|---|---|
| by Weight | 10.6 |
| by Volume | 7.7-8.8 |
| Flash Point (Seta), ° F. (° C.) | 60 (15.6) |
| Solvents | Methyl Ethyl Ketone (MEK) |
